(19) United States
(12) Patent Application Publication
(10) Pub. No.: US 2014/0200838 A1
(43) Pub. Date: Jul. 17, 2014

(54) Water Saving Device

(71) Applicant: Kevin Myers, Greenlawn, NY (US)

(72) Inventor: Kevin P. Myers, Greenlawn, NY (US)

(73) Assignee: GREEN STARTS HERE, LLC, Greenlawn, NY (US)

(21) Appl. No.: 14/156,158

(22) Filed: Jan. 15, 2014

Related U.S. Application Data
(60) Provisional application No. 61/753,208, filed on Jan. 16, 2013.

(51) Int. Cl. G01F 1/66

(52) U.S. Cl. CPC G01F 1/661
USPC 702/49; 702/45

(57) ABSTRACT

A water saving device including a housing and a processor disposed within the housing. The processor calculates a water volume expended over a period of time based on a predetermined volumetric flow rate and time. A sensor is disposed within the housing for sensing the presence of a user. The sensor is operably connected to the processor. The sensor generates a signal to cause the processor to begin calculating the water volume upon sensing the presence of a user. A display indicates the expended water volume and is operatively connected to the processor. The display shows a virtual water level which rises as time and water usage increases.

This application claims priority to U.S. Provisional Application Ser. No. 61/753,208 filed Jan. 16, 2013, the contents of which are incorporated by reference herein in their entirety.

### FIELD OF INVENTION

The present invention relates to a device for conserving or saving water by tracking water usage, and more particularly to a programmable device for determining water usage to help conserve water.

### BACKGROUND OF THE INVENTION

Fresh water conservation and water efficiency are well recognized important goals to preserve what is a most precious resource. As individuals seek to find ways to do their part in protecting the environment, such as by recycling, purchasing more bio-degradable products and installing items such as low flush toilets, individuals continue to look for ways they can protect our natural resources.

Conserving or saving water by limiting use of water is something individuals can do on a daily basis. Furthermore, limiting the use of hot water prevents the additional waste of energy required for heating. Conservation leads to decreased energy costs for users and increased environmental benefits resulting from the conservation of energy needed to heat the water.

Many devices designed to limit or control the use of water function through the connection to the water source. For example, U.S. Pat. No. 6,997,064 to Bird et al., must be in contact with the water, preferably attached to the water pipe, in order to function properly. U.S. Pat. No. 5,853,130 to Ellsworth, requires installation of a showerhead with special valves, fluid conduits, a position detector and a controller. These connections require permanent installation to a fixed source.

Available water saving devices are typically expensive and difficult to install. Purchasing and installing low-flow toilets, faucet aerators, rainwater harvesting, and low-flow showerheads, require both financial and technical capacity. Additionally, the installation of these devices is likely unavailable to those who do not own the property, and therefore, do not have the ability to modify property.

The devices listed above, are also limited to a singular function. They do not provide users with the ability to measure water usage during various events such as showering, washing dishes, watering the lawn, etc.

Use of water over a period of time, such as monthly use, is also not determinable when using the presently available devices. Such a capability would allow a person to determine when and where they are more likely to waste water, and then modify their behavior accordingly.

Finally, the present devices such as the Timed Shower Valve Manager (U.S. Pat. No. 6,899,133) and the Water Saver Shower (U.S. Pat. No. 6,016,836) both to Brunkhardt, automatically shut off the flow of water after a given period of time. These devices prevent the user from having varying control of water use based on the instant needs of the user.

Accordingly, it would be desirable to provide a device which is independent of the water supply system, consumer friendly, and provides a convenient device for monitoring water usage to promote water savings.

### SUMMARY OF THE INVENTION

The present invention provides a water saving device including a housing, a processor, a control device(s), and an indicator(s). The control device(s) and the indicator(s) are operably connected to the processor. The processor calculates a volume expended over a period of time based on a predetermined volumetric flow rate and the period of time.

The water saving device of the invention may include various data output from the processor or a memory to indicator(s). This data may include time, volume, or volumetric flow rate. Data stored in the memory may include prior volumes of water used along with date and time of use, different users, volumes of water used and dates and times of use for different users, volumetric flow rates for various water usage devices, alarm settings for various users, etc.

Indicator(s) may include display screens in or on the housing of the water saving device, auditory output, i.e., spoken information, or a personal computer or a website. The display screens may include various illustrations which help the user determine the volume of water that has been used as well as a remaining volume as it relates to the preset maximum volume.

The water saving device of the invention may include various user control device inputs including mode, set, store, start/stop, metric/standard, increase and decrease.

The predetermined volumetric flow rate of the invention may be a default value present in the processor, or it may be a volumetric flow rate input by the user.

The present invention may also provide a method of determining water usage. The method including providing a water saving device that includes a housing, a processor, and an indicator. The volume expended is calculated by multiplying a predetermined volumetric flow rate by time. The data is output to the indicator.

The present invention further provides a water saving device including a housing and a processor disposed within the housing. The processor calculates a water volume expended over a period of time based on a predetermined volumetric flow rate and time. A sensor is disposed on the housing and operably connected to the processor. The sensor generates a signal to cause the processor to begin calculating the water volume upon sensing the presence of a user. A display screen indicates the expended water volume and is operatively connected to the processor. The display screen shows a virtual water level which rises as time and water usage increase.

The present invention also provides a water saving device including a housing and a processor disposed on the housing. The processor calculates a water volume expended over a period of time based on a predetermined volumetric flow rate and time. An indicator for indicating the expended water volume is operatively connected to the processor. An infra-red sensor is disposed on the housing and operably connected to the processor for sensing the presence of a user. The sensor generates a signal to cause the processor to begin calculating the water volume upon sensing the presence of one of a user or a water flow.

The present invention further includes a method of reducing water usage. This method includes starting the timer of a water saving device at the onset of water usage. The timer is started by means of a control mechanism, primarily via a Passive Infra-Red (“PIR”) sensor or other automatic sensor. If desired, the user can activate a reset button and the timer will be restarted. The water saving device includes a housing, a processor, a control mechanism, and a display. The display and control mechanism are operatively connected to the processor. The processor determines a volume expended over a period of time based on a predetermined volumetric flow rate and the period of time, and the display indicates the volume and time expended. The display screens may include various illustrations which help the user determine the volume of water that has been used as well as the remaining volume as it relates to the preset maximum volume. The water volume expended is reviewed and water usage is terminated at a predetermined water volume.

The present invention still further provides a method of saving water including:

providing a water saving device including a processor operably connected to a sensor and a display, the processor calculating a volume of water used based on a predetermined flow rate and time, the processor storing a predetermined maximum water usage amount;

starting the timer at the onset of water usage;

the processor calculating the water usage; and

the display indicating the amount of water used in relation to the predetermined maximum water usage amount.

### BRIEF DESCRIPTION OF THE DRAWINGS

FIG. 1 is a front elevational view of an embodiment of a water saving device of the present invention.

FIG. 2 is a rear elevational view of the water saving device of FIG. 1.

FIG. 3 is a top perspective view of the water saving device of FIG. 1.

FIG. 4 is a schematic view of the water savings device of the present invention.

FIG. 5 is a flow chart displaying various functions of the water savings device.

FIG. 6 is a front view of an alternative embodiment of a water saving device of the present invention.

FIG. 7 is a side perspective view of the water saving device of FIG. 6.

FIG. 8 is a rear perspective view of the water saving device of FIG. 6 showing a back plate separated therefrom.

FIG. 9 is front perspective view of the water saving device of FIG. 6 showing a back plate separated therefrom.

FIG. 10 is a side perspective view of an alternative embodiment of the water saving device with a back plate secured thereto.

### DETAILED DESCRIPTION OF THE PREFERRED EMBODIMENTS

The water saving device of the present invention monitors water usage by providing real time information relating to water expenditure. Such information may be presented in illustrations which present the data in a format that is easier for the user to interpret than traditional data. When made aware of the amount of water that has been used, a user can modify their behavior to reduce the amount of water used during a particular event such as showering or washing their hands, thereby saving water.

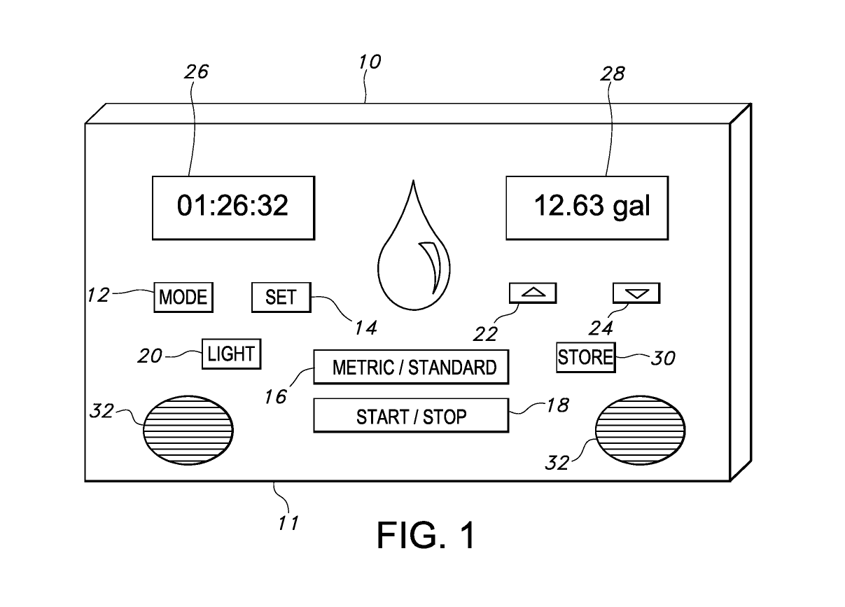

With reference to FIGS. 1-4, the water saving device 10 may include a housing 11 which can be constructed of polymer resin or other water resistant material. Housing 11 can be injected molded from a singular type of polymer or a mixture thereof in a manner well known in the art. Housing 11 can be molded in various shapes and colors according to user needs or preference. Housing 11 is preferably suitably sealed in order prevent the ingress of moisture.

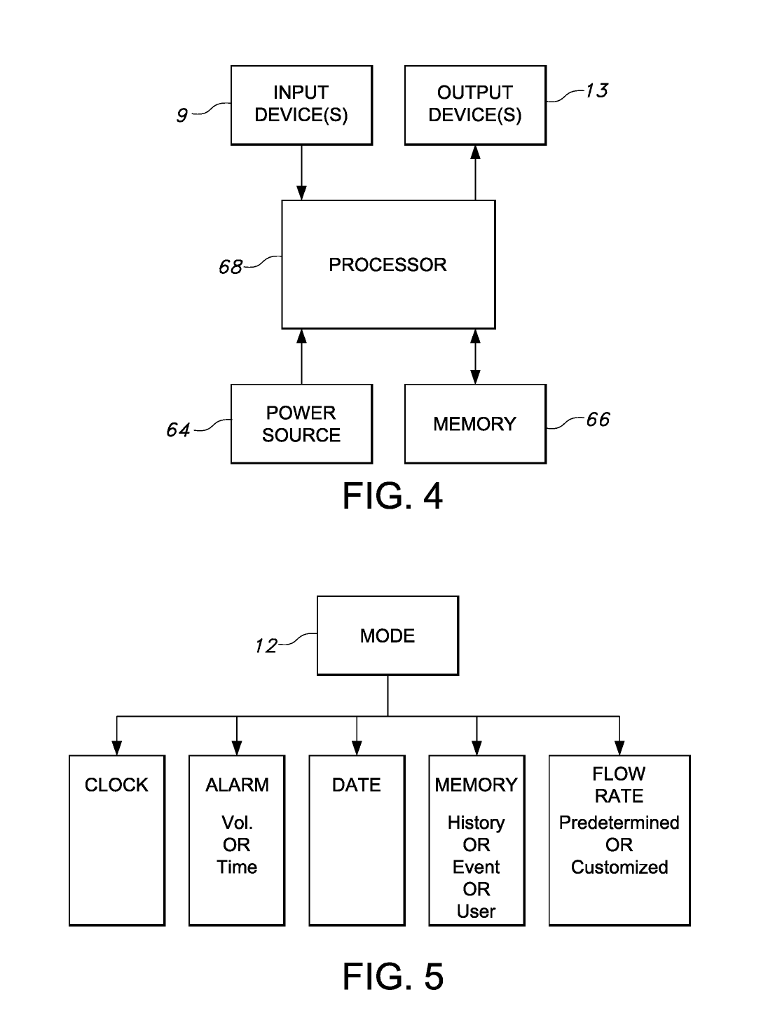

Housing 11 further includes a processor 68 (See FIG. 4) for calculating the volume of water used during a given event according to the following function:

Q*t=v

where Q is volumetric flow rate, t is time and v is volume of water used. Volumetric flow rate Q may be an estimated flow rate for a given device.

Processor 68 calculates a volume of water used (v) during a specific water usage event. In calculating the volume of water used (v), the volumetric flow rate (Q) may be a default value present within processor 68. The default value may be based on industry standard volumetric flow rates or legislated volumetric flow rates for given devices, i.e., 2.5 gal/min at 80 psi in shower heads and household faucets.

In certain embodiments, the user may input a specific volumetric flow rate (Qₛ). The user may determine the volumetric flow rate (Q) of a given water usage device by consulting the water usage device owner's manual or contacting the manufacturer of the water usage device. Alternatively, the user may independently measure the volumetric flow rate Q by determining the amount of time it takes for a water usage device to fill a given volume, such as a gallon sized container, and entering this amount into the processor 68 of the water saving device 10. The water saving device does not require integration with or connection to the water usage device in order to determine or sense flow rate. Accordingly, the present invention may be easily moved from one place to another.

Time (t) is measured by a timer located within processor 68. The volume of water consumed (v) is continuously evidenced (i.e., sum of v₁+v₂+v₃ . . . v_{end}) to the user during a water usage event. Accordingly, the total volume of water used is continuously calculated and may be displayed. When the device is stopped, the evidenced volume (v_{end}) may be stored.

Processor 68 may be configured or programmed to perform a secondary additive function. Accordingly, the stored volume from a first water usage event (vₑₙₐ₁) may then be added to volumes used during additional water usage events (vₑₙₐ₁+v_{end2→∞}) within a specific time providing the user with a method of determining, for example, daily, weekly, or monthly water usage.

Processor 68 may be any type of processing device, programmable controller, CPU, ASIC, capable of performing additive and multiplicative functions. Processor 68 receives input(s) data from control devices(s) located on housing 11 of water saving device 10. Processor 68 outputs data to output mechanism(s) useful to the user.

Processor 68 may receive power from a power source 64. The power source 64 may be, for example, a battery, solar energy source, etc. The power could also be supplied by a power adapter plugged into an electrical outlet.

In certain embodiments, processor 68 is operatively connected to a memory storage device 66. Memory storage device 66 may retain stored data such as volumetric flow rates for various water sources, individual user data, and other information. The memory storage device 66 may be part of the processor or separate from it. Memory could also be removable from the water savings device in the form of a memory card.

Processor 68 may receive data input via input control devices 9 or controller(s) operable by the user and provide data output via output devices 13. With reference to FIG. 1, control devices 9 may include, for example, mode 12, set 14, metric/standard 16, start/stop 18, store 30, increase 22 or decrease 24 or light 20. Output(s) may include, for example, time/alarm/clock, volume usage output, or volumetric flow rate output via easy to read illustrations which represent the data. The control devices for user input(s) and processor 68 output(s) may be located in or on housing 11 of water saving device 10.

The control devices may include, for example, buttons, knobs, switches, touch screen, or other mechanisms. Certain embodiments may allow for vocal command control rather than requiring use of a tactile mechanism. The control devices may be operatively connected to the processor 68. Alternatively, there may be only one control device from which various functions of the water saving device 10 may be selected.

Mode 12 may be used to navigate a variety of functions optionally available in water saving device 10. Functions can include, for example, clock, date, alarm, memory, or volumetric flow rate.

One embodiment includes a store control device 30. This control device allows users to retain data in the memory 66. Data stored may be the volumetric flow rate for various water usage devices, for example, different showers, sinks, hoses, etc. Data stored in memory 66 may also include results (i.e., total volume used) for different water usage events for a single user. Additionally, data for multiple users may be stored in memory 66 using store control device 30.

Set 14 may be used to control the water saving device 10. In the absence of a store control device 30, set 14 may be used to store data or figures in memory 66. Additionally, set 14 may be used, for example, to set a clock, volumetric flow rate, or alarm.

In certain embodiments, the user may store multiple water usage events during a specific period which may be added up to display total volume used in that time period. Optionally, the user may upload the stored data to a computer or other device. The water usage data may then be tracked over time, for certain events, for different users, or for other purposes.

Data that is stored using store control device 30 or set control device 14, in memory 66 may be reviewed by the user. Mode 12 can be used to view stored data using the memory function.

Start/stop control device 18 may be used to begin and end timing of a water usage event. It may also be used to start/stop a timer, an alarm or other features having a beginning and end. Reset may be used to restart timing when using the auto function.

Certain embodiments include increase 22 and decrease 24 control devices, represented by arrows. These mechanisms may be used to increase or decrease a value or input a new value into processor 68 for storage in memory 66.

In various embodiments of the invention, increase 22 and decrease 24 control devices may be used to adjust the volumetric flow rate for various water usage devices (showers, sinks, etc.) from a default value. Increase 22 and decrease 24 control devices may also be used in conjunction with mode 12 to review various functions or to increase or decrease a numeric value.

Certain embodiments may include a light 20 control device. Light 20 may be used to turn on a backlight for a visual output device or a light on the water saving device 10.

Two optional audio outputs/inputs 32 may be used to provide an audible alert to users. In certain embodiments, audio output/input 32 may receive audible instruction from a user and transfer that instruction to the processor 68.

The water saving device 10 may further include a metric/standard control device 16 allowing a user to change the data output to indicate gallons per minute or liters per minute.

Water saving device 10 may be capable of various functions not immediately evidenced by the control devices. A user is made aware of these functions by utilizing mode 12, or mode 12 in conjunction with increase 22 and decrease 24 control devices. As stated above, functions may include a clock and date function. The clock function may be a 12 or 24 hour clock, digital or standard, or any other type of clock. The date function may provide the date at the moment of use of water saving device 10.

A function such as an alarm may also be available. The alarm function may alert a user that a specific period of time has elapsed; a specific volume of water has been reached; or at the occurrence of some other preset event. The alarm function may make use of an auditory output 32 or visual output such as a flashing light.

A memory function may be used to review data stored in memory 66. This data may include, for example, different users, volumetric flow rates for various water usage devices, stored water usage for various events, etc.

A flow meter function may allow a user to determine the time it takes for a certain water usage device to fill a specific volume. By using the flow meter function the data obtained is input to processor 68 which performs the necessary calculation and determines the volumetric flow rate for the water usage device. The result may then be stored in memory 66 using the store mechanism 30 or set mechanism 14.

A volumetric flow rate function may allow a user to review certain stored volumetric flow rates including default volumetric flow rates. Additionally, this function may be used to enter volumetric flow rates for various water usage devices.

Processor 68 outputs data to output control device(s) or indicators which may be located on the housing 11 of the water saving device 10. If the output control device(s) are not located on the housing 11, data that is output may be sent from processor 68 to separate output control device(s) such as a computer, cell phone, or other receiving device.

Output devices(s) may be in the form of a visual display. Optionally, output(s) may be audible, for example, a spoken volume or a spoken time. An additional embodiment may include both auditory and visual output.

In an alternative embodiment, the volume of water (v) used may be indicated to a user on a water use output device 28 which may be supported on or in the housing 11. The amount of water used may be output by the processor 68 in gallons, liters, cubic meters, cubic feet, or other volume measures.

In an alternative embodiment, housing 11 may further include a time output device 26, which may provide the actual time of day, a count down or count up time, or alarm time—either time remaining or time expended.

Various embodiments may include a volumetric flow rate output device 50 (see FIG. 3) that receives from processor 68 the volumetric flow rate used to calculate the total volume of water used. Volumetric flow rate output mechanism 50 may indicate a default value for the volumetric flow rate. If a user inputs a volumetric flow rate into processor 68, the volumetric flow rate output mechanism 50 may exhibit the volumetric flow rate input by the user. Additionally, the user may select the volumetric flow rate which they desire to use for a given water usage event. The volumetric flow rate output mechanism 50 will then indicate the volumetric flow rate selected.

In an alternative embodiment, only one output device may be included and the time, volume, and/or volumetric flow rate may be output by processor 68 for user receipt via this output device.

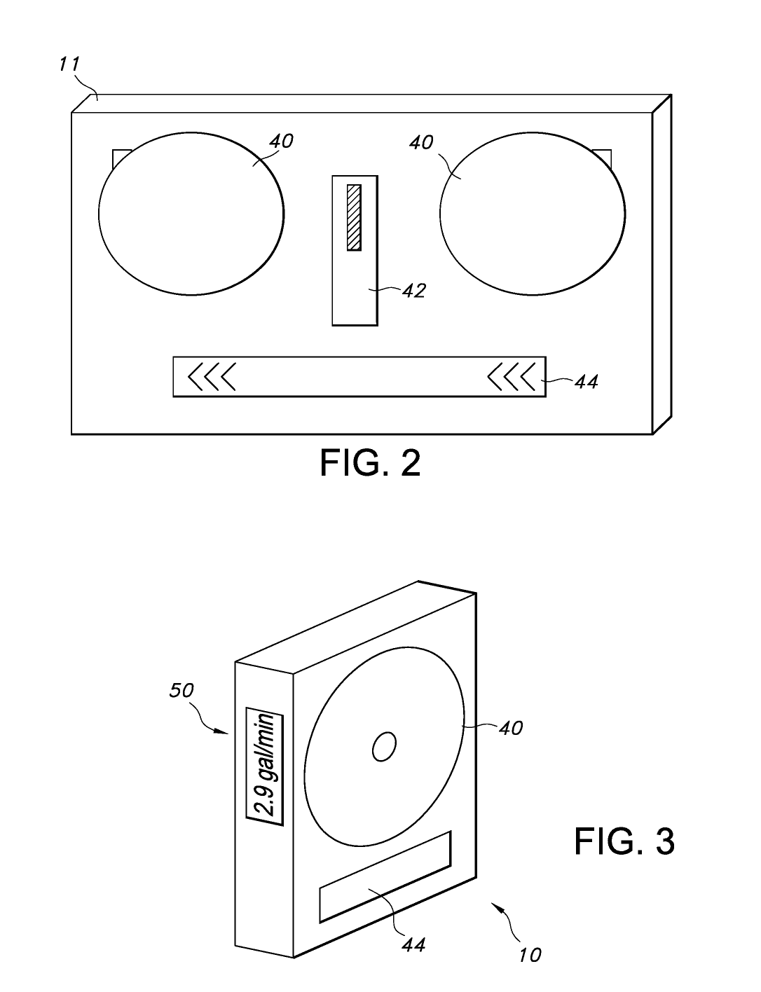

With reference to FIG. 2, the anterior portion of water saving device 10 may include a covered opening 44 to retain a power source 64 (See FIG. 4). Power source 64 may be a battery, solar, or the device may plug in to a different source of power.

In a further alternative embodiment, the anterior of the water saving device 10 may have one or more support means, for example, suction cups 40, a collapsible stand 42. The support means may be a hanging device, rope, or it may be a more permanent mechanism of attachment such as a screw or tape backing. Suction cups 40 optionally provide easy attachment to damp surfaces such as, for example, a shower stall. Collapsible stand 42 allows the user to place the device in alternate locations such as on the sink or other surfaces adjacent to areas where water is used.

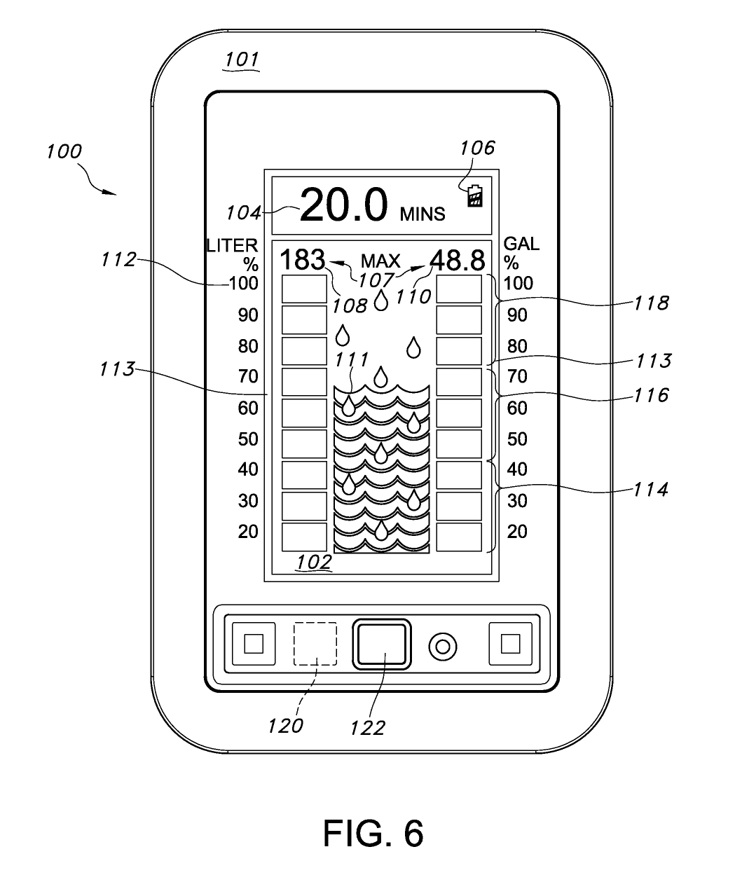

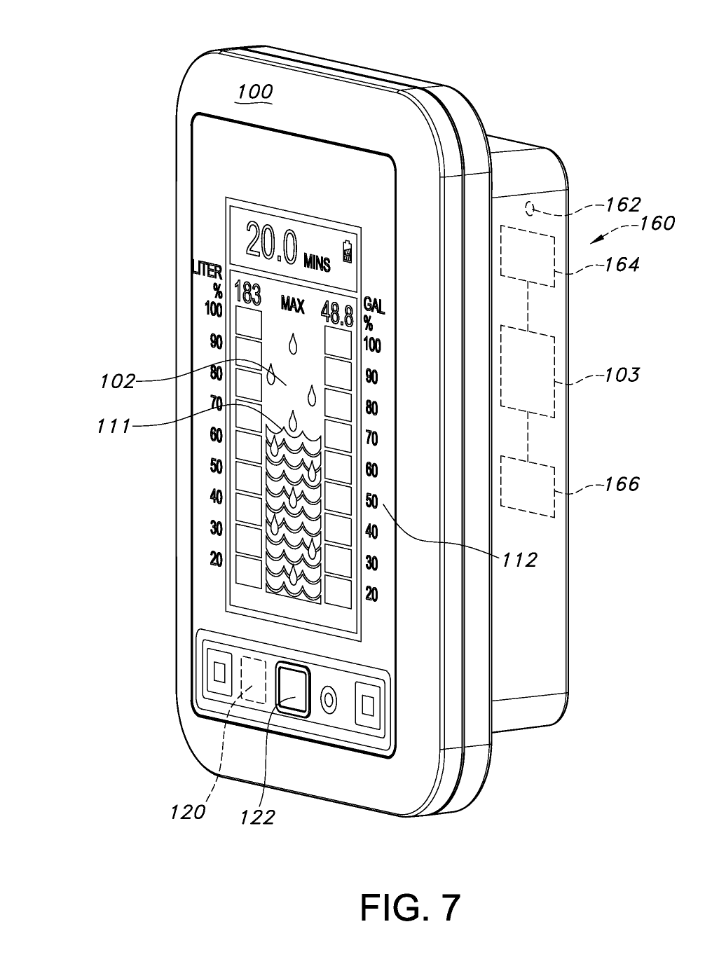

With reference to FIGS. 6-10 a further embodiment of a water savings device is shown. The water saving device 100 may include a housing 101 in which is disposed a processor 103 (FIG. 7). The housing 101 can be constructed of polymer resin or other water resistant material. Housing 101 can be injected molded from a singular type of polymer or a mixture thereof in a manner well known in the art. Housing 101 can be molded in various shapes and colors according to user needs or preference. Housing 101 is preferably suitably sealed in order prevent the ingress of moisture.

The processor 103 may be configured with hardware and/or software to calculate the amount of water volume used for a given time period based upon a flow rate, Q*t=v. The processor can also calculate elapsed time and direct the storage of data. The water volume value determined by the processor 103 may be outputted to one or more visual displays 102 supported on the housing. The display 102 may include a LCD display screen operably connected to the processor 103. However, it is within the contemplation of the present invention that other types of visual indicators or displays may be used.

The visual display screen 102 may include a time indicator 104, a battery level indicator 106, and a maximum volume amount 107 (in both liters 108 and gallons 110), which is both preset and defined by the user. The maximum volume amount would be the maximum value one desires to use for a given event. For example, if a user desires to use no more than 15 gallons for a shower, the user could set the maximum volume amount to 15.

The display screen 102 may also include an illustrated virtual water level 111, which serves as an indicator of the current value of the total calculated volume of water (defined below). The virtual water level 111 may be displayed as a water level with ripples or other visual representation which gives the appearance of water having a generally horizontal upper boundary that increases in height over time to represent increasing water usage.

As the water usage event commences, the virtual water level 111 rises in real-time, thereby providing the user with a clear indication of the amount of water being used. The rising water level also correlates to both a static percentage scale and a color coded scheme as described below. The virtual water level may form a virtual column of water that appears to rise as the water usage increases. When the maximum water usage or time is reached the water level is at the top of the column. This visual indication works with a user's natural inclination that when water has risen to the top of a container, it is time to stop the water flow.

As the virtual water level 111 rises on the display, it passes the static percentage scale 112 of the predetermined maximum volume amount. The static scale 112 ranges from 0% to 100% and represents the percentage of the maximum water volume or time interval that has been previously set by the user. When the virtual water level reaches an upper limit denoted by a 100% mark, the user knows that the maximum predetermined amount of water usage has been reached and that they should stop using water.

The display screen 102 may also include color indicators 113 in the form of colored blocks, traveling from a green zone 114 to a yellow zone 116 and a red zone 118. At a glance a user can determine how much water they are using. In the color coded scheme, which is used in conjunction with the percentage scale, the color green represents the first one-third (33%) of water or time usage. The green alerts a user that they have a fair amount of time before they reach the water usage limit. The color yellow represents the next one-third (33%-66%) of water or time usage, and yellow alerts the user that they are approaching the water usage limit. The color red represents the final one-third (66% to 100%) of water or time usage. Red alerts the user that they are close to reaching the water usage limit and should consider ending the water usage. This green, yellow, red color scheme works with a user's preconceived awareness of these notification colors and permits one to quickly and easily determine the status of the water usage.

In one embodiment, the color indicators may be fixed markers disposed on one or both sides of the virtual water level indicator 111. As the water level rises, it passes the color indicators. Alternatively, the color indicator blocks may illuminate as the water level reaches them.

The virtual water level 111, scale 112 and color-coded scheme correlate to the preset maximum water volume 107. When a user sets a maximum volume or maximum time, the maximum value correlates to 100%. Therefore, when a user sets a maximum water volume, the processor 103 controls the display 102 such that the position of the virtual water level correctly indicates the amount of water usage in relation to the maximum preset water volume. For example, if a user sets the maximum usage as 50 gallons, the virtual water level will indicate 100% when 50 gallons of usage has been calculated. When 25 gallons of water usage has been calculated the virtual water level will indicate 50%. This way, the user by looking at the display can quickly ascertain where their water usage is in relation to the maximum preset amount. Such visual representations clearly alert a user as to how much water they are using. This assists a user in limiting the amount of water they use for a particular activity, thereby saving water.

The water saving device housing 101 may also include a sensor 120 operably connected to the processor 103. The sensor 120 may activate the device 100 and start the time indicator to begin the water consumption calculation. The sensor 120 may be a non-contact sensor such as PIR or other automatic proximity sensor that senses the presence of a user proximate to the device. For example, if the device is used in a shower, the sensor 120 may detect that a user has entered the shower. Alternatively, the sensor 120 may alternatively, or in addition to, detect when the water has been turned on. In this embodiment, the sensor 120 generates a signal that activates the device 100 and causes the processor to begin calculating the water volume. The sensitivity of the sensor can be selected so that the water saving device 100 is activated by either the presence of running water or a user in proximity to the device. The display screen 102 will then show the amount of water used and time as described above. Therefore, the water saving device 100 is automatically activated by the PIR and no separate activation is required by the user.

When a user completes the water usage activity and moves away from the sensor for a predetermined period of time, the water savings device 100 may stop calculating and display the final water usage information. The sensor 120 and processor 103 may be configured to allow for loss of sensing of the user for short periods of time yet keep the device operating to account for situations when the user has temporally moved out of sensing range but is continuing the water usage event.

The housing may further include a user input 122 in operable communication with the processor for allowing a user to affect the operation of the device 100. The user input may be in the form of a SET mechanism 122 operably connected to the processor. The SET mechanism 122 can be used to restart the timer as well allowing the user to enter settings as will be described below.

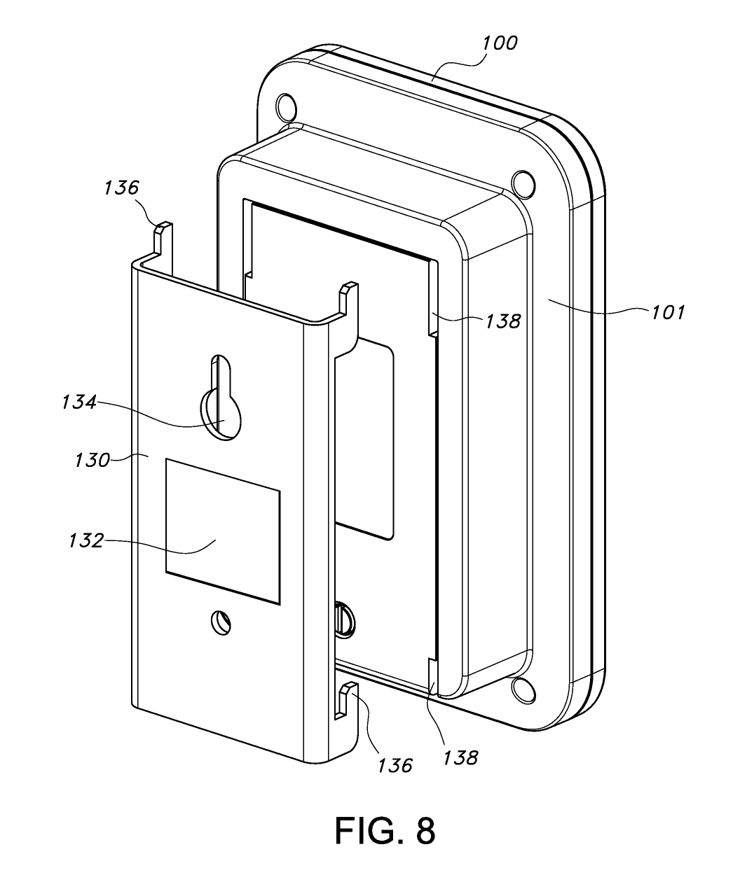

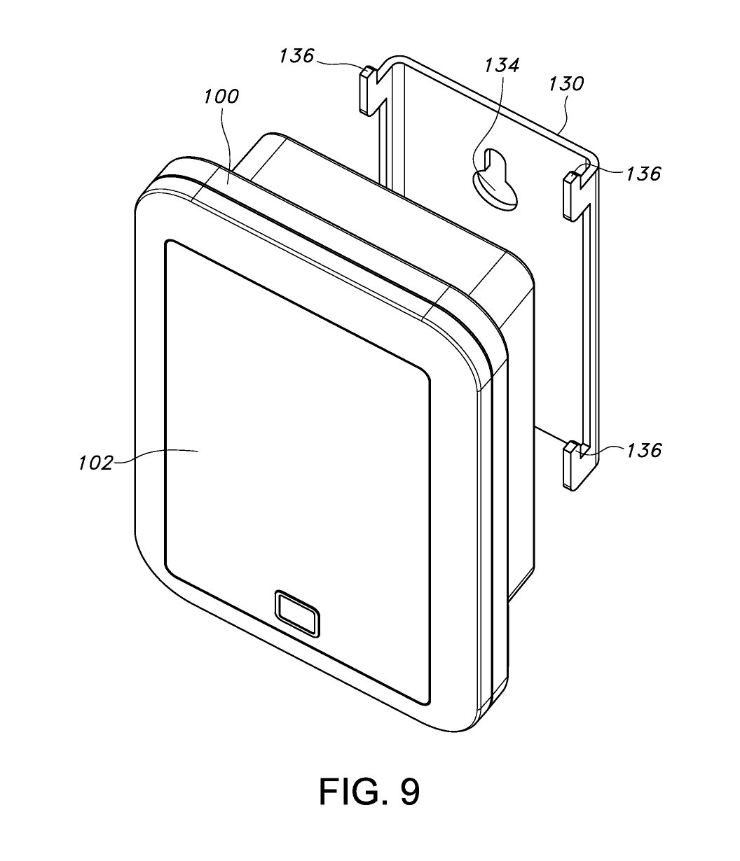

With reference to FIGS. 8 and 9, the anterior of the water saving device 100 may have a back plate 130 which purpose is to secure the device to the wall. The back plate 130 easily and securely locks into the back of the device 100, allowing for easy cleaning access as well as battery change. The back plate 130 is secured to the mounting area via a waterproof adhesive tape 132 or a screw using a slotted opening 134.

In order to removably secure the water saving device 100 from the back plate 130, the back plate 130 may have a plurality of upwardly extending tabs 136. The tabs may be received in corresponding slots 138 formed in the back of the water savings device 100. The device 100 may be secured to the back plate 30 by positioning the device such that the slots 138 align with the tabs 136 and moving the device 100 so that the tabs 136 enter the slots 138. Once the tabs are in the slots, a slight downward motion of the device 100 relative to the back plate 130 locks the device thereto. In order to remove the device 100 from the back plate 130, the device 100 may lifted upwardly and pulled away from the back plate.

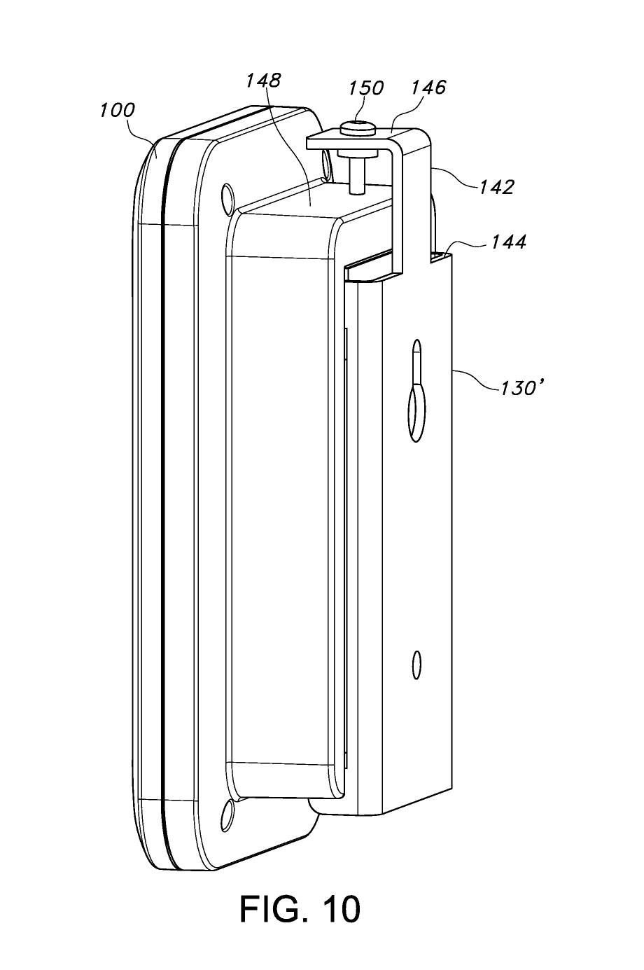

In an alternative embodiment shown in FIG. 10, the back plate 130′ may have a securement device 140 which prevents unwanted removal of the water savings device 100 from the back plate. The securement device 140 includes an L-shaped member including a first portion 142 extending upwardly from a back plate top edge 144 and a second portion 146 extending from the first portion over the water savings device rear portion 148. A security fastener 150 extends through the second portion and can be adjusted to engage and disengage the water saving device, such as by turning the fastener 150 to allow a threaded engagement to move the fastener. When the security fastener 150 engages the device 100, this prevents the device from moving relative to the back plate 130′. Since movement is prevented, the water saving device 100 cannot be lifted upwardly to separate it from the back plate 130′. Therefore, the device is unremovably retained on the back plate. Accordingly, if the back plate 130′ is fixed to a mounting surface, the device unremovably retained. In order to remove the device, the security fastener 150 would be moved away from the device such that the device can be lifted off the back plate. In order to enhance the security feature of the back plate 130′, the fastener 150 may be of a type that requires a special tool or bit to engage the fastener and turn it.

The water saving device 100 may have an output device 160 in order to allow the water saving device to communicate with a remote device. For example, the remote device may be a mobile phone or other electronic device e.g., PC, laptop, tablet, etc. The output device may be a port 162 having a watertight cover and/or a transmitter/receiver 164 each being operably connected to the processor 103. The connection may be done physically through a cord, in which case the water saving device would have an output port to receive a connector. Alternatively, the connection may be done wirelessly through a WiFi or Bluetooth connection. In such an embodiment, the output device may be the wireless transmitter/receiver. It is also contemplated that the water saving device could have multiple modes of communicating with the remote device both physically and wirelessly. The physical connection may be through a USB port or other port well-known in the art. The output device may be operably connected to the processor 103. Accordingly, when a user completes a water savings event and stops the timer, this information can be saved in memory 166. The memory could be part of or separate from the processor.

It is also within the contemplation of the present invention that the device may have a selection for general types of water uses, for example, shower, bath, hand washing, tooth brushing, etc. The user could select a particular water use event and obtain data with regard to each of these events. This data could then be uploaded to a computing device operating with standalone software or via web driven software in which the user's data may be correlated and presented. This software would allow a user to keep track of their water usage for the different events through a given time period. This software may have charting ability in order to give the user a graph or chart to show if the water usage is increasing or decreasing. It is within the contemplation of the present invention that the software could include additional features which permit the user to track their water usage.

The ability for the water saving device to transmit data to an external device can allow a user to view the data as well as a summary of the data. The data may be presented in various forms such as a graph or table to that the user can quickly see how much water they are using. In addition, the water savings device may be connected to a computing device via an output port 162 as described above. Once connected, the water savings device 100 may upload over a network, such as the internet, the stored water use data to a web site. The web site could collected the data and allow one to see water usage of others for a particular water use event. This information could be sorted geographically so that one may log onto a web site and find out how much water others are using in the proximate area or in a town, country, state, or other geographical area. The web site may have software capable of receiving, storing and processing data in order to allow the data received from a plurality of water saving devices to be correlated and displayed. Allowing users to track their own usage and compare their own usage against others allows a user to be more aware and help them to modify their behaviors. The web site may be able to issue virtual tokens or other virtual prizes to individuals who show low water usage for different water usage events. Such a “gamefication” influences both participation and behavior of the activity.

The operation of the water saving devices 10 and 100 will now be described. Water saving devices 10, 100 may be used adjacent to water usage device such as a shower. In a shower application, the anterior of water saving devices 10, 100 may be connected to a shower wall using the back plate 130 (FIG. 8) via waterproof adhesive tape, a screw, or other connection devices such as suction cups 40 (FIG. 2). Alternatively, the user may employ stand 42 (FIG. 2) or other connection device.

The devices 10 and 100 may be programs with default settings such as a volumetric flow rate and/or maximum time or volume settings. For example, the flow rate may default to 2.5 gallon per minute and the maximum time to 10 minutes with the maximum volume set for 25 gallons. However, these values may be modified by a user.

In certain embodiments of the invention, the user may modify the default volumetric flow rate to reflect the actual volumetric flow rate during their water usage event. In the embodiment shown in FIGS. 1-6, mode mechanism 12 may be used to view various functions and set mechanism 14 may be used to select “flow rate.” Increase 22 and decrease 24 mechanisms may then be used to enter a specific volumetric flow rate. Metric/standard mechanism 16 may be used to identify the proper value for the volumetric flow rate entered and the set mechanism 14 may be used to finalize the selection. Finally, store mechanism 30 may be used to send the data to memory 66. This value will then be used to calculate total water usage volume for the event.

In the embodiment shown in FIGS. 6-10, the volumetric flow rate may be set by pressing the SET button and keeping it pressed for approximately 2 seconds. Upon release a CALIB icon will appear along with the current flow rate in gallons per minute, and corresponding liters per minute. The user can then press the SET mechanism and keep it pressed for approximately 2 seconds. Upon release of the SET mechanism, the SETUP icon will appear on the display, and the MAX gallons per minute and corresponding liters per minute will increment to the maximum, then start to decrement to the minimum. When the desired rate is displayed, the user momentarily presses the SET mechanism. The new flow rate setting will now be programmed into the water savings device. It is within the contemplation of the present invention that the flow rate and other setting could be set using one or more mechanisms, up down arrows or input devices in a manner know in the art.

In certain embodiments of the invention, the user may input the maximum desired time, or maximum volume amount used during the water usage event. In the embodiment shown in FIGS. 7 to 10, to accomplish this, a user would press the SET mechanism and keep it pressed for approximately 2 seconds. Upon release the MAX icon will appear, and the minutes will increment to the maximum, the decrement to the minimum. The corresponding maximum volume will change in accordance with the flow rate programmed above. When the desired time is displayed, momentarily press the SET mechanism. The new maximum time will now be programmed into the monitor. Momentarily press the SET mechanism, and the water savings device will return to its normal operation. The new settings will remain until the batteries are removed. Since the flow rate has been set, the maximum volume amount is a function of time. Therefore, by adjusting the time the maximum volume amount is also adjusted. For example, if the flow rate is 2.5 gal/min and a user wishes to limit water usage to 25 gallon, then they would set the time for 10 minutes.

Several volumetric flow rates may be entered and stored in the device. This allows a user to enter volumetric flow rates for different shower heads or faucets. A specific user is thereby provided the ability to measure their individual use during various activities.

During subsequent water usage events, the user may select which volumetric flow rate the processor will use to calculate the water volume consumed. The volumetric flow rate in use may be output to volumetric flow meter output mechanism 50.

In order to reset the water savings device to the original default settings, power may be removed from the processor, such as by removing the batteries for approximately 20 seconds, then reinserting the batteries.

Once the water saving device has been set up it is ready for use. In the embodiment shown in FIGS. 6-10, the water saving device 100 turns on when activated via the sensor 120 disposed in or on the housing 101. For example, if the device is used in a shower, the sensor may detect that a user has entered the shower. Alternatively, the sensor may also detect when the water has been turned on. In this embodiment, the device 100 is automatically activated and no separate activation is required by the user.

During normal operation, when the water saving device 100 detects someone in its immediate proximity, the digital timer 104 will start to increment and the water level indicator 112 will advance. The timer 104 will continue to advance as long as it continues to detect someone in its immediate proximity and/or the flow of water. In order to account for a temporary loss of detection, such as a user bending to pick up a bar of soap, the timer 104 will continue to advance for approximately 90 seconds. If detection is lost, the timer will reset. The setting of maximum minutes, gallons, and liter will appear on the display. The virtual water level 111 will rise alerting the user as to how close they are to the maximum set water consumption limit. When they user is finished with the use of water, they will move away from the device 100 and shut off the water. The timer will stop.

In order to restart the device, the SET button should be pressed momentarily. The display will go to the default settings.

In the embodiment of a type shown in FIGS. 1-5, the water saving device 10 can be turned on by use of the start/stop 18. Processor 68 of water saving device 10 will default to a standard shower volumetric flow rate.

During the water usage event, the user will be continually made aware of their water usage volume via output from processor 68. When the user has completed their water usage event, start/stop mechanism 18 may again be utilized. At this time the user will be made aware of the final volume expended. The user may then choose to store this information in memory 66 by using store mechanism 30.

The memory function allows the user to store a certain number of water usage events in memory 66. By storing the event, memory 66 may retain the time, date, duration, and volume of water used. Optionally, the device memory is remotely accessible and stored data can be uploaded to a computer or other device. This information can then be used to track water usage history.

The water saving device may include other features. As shown in FIG. 1, the device may include a 12 hour or 24 hour or other type of clock output via 26. The clock can be set by pressing the mode 12 until the “clock” is displayed and using the set 14 mechanism to send this data to memory 66. Mode 12 may then be used to toggle between hours, minutes, seconds and 12 or 24 hour clock. Increase 22 and decrease 24 mechanisms may then be used to input the correct time which may be stored using set mechanism 14. The same method may be used to set the date.

An alarm function may set by using mode mechanism 12 to select “alarm.” After using set 14, mode 12 may be used to toggle between “volume” and “time” and after making the selection, set using set 14. The user may then input the accurate volume or time for storage in memory 66 by utilizing increase 22 and decrease 24 mechanisms and set 14 to set the alarm. The user may further select the auditory or visual alarm using mode 12 and set 14. Audio input/output(s) 32 may provide an audible alarm.

Should the user select an audible alarm, the alarm volume is adjustable by using the increase 22 and decrease 24 inputs. The type of sound produced is preset from a limited number of audible options.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A water saving device comprising:
a housing;
a processor disposed within the housing, the processor calculating a water volume expended over a period of time based on a predetermined volumetric flow rate and time;
a sensor disposed on the housing and being operably connected to the processor, the sensor generating a signal to cause the processor to begin calculating the water volume upon sensing the presence of a user; and
a display screen for indicating the expended water volume and being operatively connected to the processor, the display screen showing a virtual water level which rises as time and water usage increases.

2. A water saving device of claim 1, wherein the sensor is a passive Infra-Red sensor.

3. A water saving device of claim 1, wherein the display includes a percentage scale and the rising virtual water level indicates a percentage of water usage in relation to a predetermined maximum water volume.

4. A water saving device of claim 1, wherein the display includes a plurality of zones differentiated by color indicating water usage.

5. A water saving device of claim 1, wherein the predetermined volumetric flow rate is selected from a predetermined group of flow rates.

6. A water saving device of claim 1, wherein said predetermined volumetric flow rate is set by a user.

7. A water saving device of claim 1, wherein a predetermined maximum water volume is set by a user.

8. A water saving device of claim 1, wherein the processor further calculates and stores the total volume used during multiple water usage events.

9. A water saving device comprising:
a housing;
a processor disposed on the housing, the processor calculating a water volume expended over a period of time based on a predetermined volumetric flow rate and time;
an indicator for indicating the expended water volume operatively connected to the processor;
an infra-red sensor disposed within the housing being operably connected to the processor, the sensor generating a signal to cause the processor to begin calculating the water volume upon sensing the presence of one of a user or a water flow.

10. A water saving device of claim 9, wherein the predetermined volumetric flow rate is selected from a predetermined group of flow rates.

11. A water saving device of claim 9, wherein said predetermined volumetric flow rate is set by a user.

12. A water saving device of claim 9, wherein a predetermined maximum water volume is set by a user.

13. A water saving device of claim 9, wherein the processor further calculates and stores the total volume used during multiple water usage events.

14. A water saving device of claim 9, wherein the indicator is a visual display screen.

15. A water saving device of claim 14, wherein the visual display screen includes a virtual water level, wherein the water level rises over time to indicate water usage.

16. A water saving device of claim 15, wherein the position of the virtual water level is responsive to a preset maximum water usage volume.

17. A water saving device of claim 15, wherein the display includes a percentage scale and the rising virtual water level indicates a percentage of water usage in relation to a predetermined maximum water volume.

18. A water saving device of claim 15, wherein the virtual water level includes a generally horizontal upper boundary that increases in height over time to represent increasing water usage.

19. A method of saving water comprising:
providing a water saving device including a processor operably connected to a sensor and a display, the processor calculating a volume of water used based on a predetermined flow rate and time, the processor storing a predetermined maximum water usage amount;
starting the timer at the onset of water usage;
the processor calculating the water usage; and
the display indicating the amount of water used in relation to the predetermined maximum water usage amount.

20. The method as defined in claim 19, wherein the display is a virtual water level which rises with increased calculated water usage.

21. The method as defined in claim 20, including setting the flow rate prior to starting the timer.

22. The method as defined in claim 19, wherein the sensor is a non-contact sensor activated by one of the presence of the user or the flow of water.
